(19) United States
(12) Patent Application Publication
(10) Pub. No.: US 2006/0106156 A1
(43) Pub. Date: May 18, 2006

(54) Crosslinkable silicone material having a long processing time and storage stability

(75) Inventor: Christof Woerner, Burghausen (DE)

Correspondence Address: BROOKS KUSHMAN P.C., 1000 TOWN CENTER, TWENTY-SECOND FLOOR, SOUTHFIELD, MI, 48075, US

(73) Assignee: Wacker-Chemie GmbH, Munich (DE)

(21) Appl. No.: 11/270,112

(22) Filed: Nov. 9, 2005

(30) Foreign Application Priority Data
Nov. 18, 2004 (DE) 10 2004 055 690.3

(51) Int. Cl. C08L 83/04; C08L 83/00

(52) U.S. Cl. 524/588

(57) ABSTRACT

Crosslinkable silicone materials having both extended processing time and storage stability include hydrosilylatable organopolysiloxane and Si—H crosslinker, both containing trifluoropropyl groups, the crosslinker free of terminal Si—H functionality. Silicone elastomers prepared therefrom have good solvent resistance and outstanding mechanical properties.

### BACKGROUND OF THE INVENTION

1. Field of the Invention

The invention relates to crosslinkable silicone materials having extended processing time and extended storage stability, to their use, and to a process for their preparation. The silicone elastomers prepared therefrom have good solvent resistance and outstanding mechanical properties. The invention further relates to a process for the preparation thereof and the use of the elastomers.

2. Background Art

The requirements with regard to addition-crosslinking silicone materials and the silicone rubbers obtained therefrom are constantly increasing with regard to storage stability and processing by injection moulding. The requirements target improvement in the demoulding characteristics and improvement of the part quality and the cycle time in comparison with prior art systems. At the same time, the silicone rubbers prepared from these addition-crosslinkable silicone materials are required to have good resistance to media and good mechanical properties.

In order to improve the solvent resistance of silicone elastomers with respect to nonpolar solvents, polar trifluoropropylsiloxy units have been incorporated into a polyorganosiloxane component of addition-crosslinkable silicone materials. In order to ensure complete crosslinking of the polyorganosiloxane containing trifluoropropyl groups and having at least two aliphatic carbon-carbon multiple bonds, SiH groups of a crosslinking agent must be present in a sufficient amount.

However, the reactivity of the SiH crosslinking agent must not be too high, since otherwise the processing time, i.e. the time in which the uncrosslinked silicone material is still sufficiently flowable and is not yet crosslinked after mixing of all components, is too short. However, the reactivity of the SiH crosslinking agent and the excess of SiH groups relative to unsaturated groups also must not be too low, since otherwise the crosslinking time becomes too long and hence the productivity in the production of shaped articles, for example by injection moulding, is too low.

U.S. Pat. Nos. 4,029,629, 4,529,752 and 4,599,374, for example, disclose addition-crosslinking silicone materials which contain vinyl-terminated poly(3,3,3-trifluoropropylmethyl)siloxanes and SiH crosslinking agents. The SiH crosslinking agents described contain H—SiRR′—O units, either in resin-like structures or at the chain end of linear crosslinking agents. These groups are extremely reactive with respect to hydrosilylation and result in very rapid crosslinking of the addition-crosslinking silicone materials.

The silicone materials thus obtained have a very short pot life, so that very short processing times also result therefrom. Moreover, the storage stability of the uncrosslinked materials is substantially adversely affected when using SiH crosslinking agents having H—SiRR′—O units.

### SUMMARY OF THE INVENTION

It was therefore an object of the present invention to provide silicone materials which crosslink completely by means of addition, and are distinguished by a sufficiently long processing time at room temperature after mixing of all components, as well as rapid and complete crosslinking at higher temperatures. Furthermore, the uncrosslinked silicone materials preferably have outstanding storage stability. The silicone elastomers prepared from these silicone materials are distinguished by good solvent, fuel or oil resistance, and outstanding mechanical properties.

These and other objects have been surprisingly achieved when, for complete crosslinking, not only is an excess of SiH groups present but also compatibility of the SiH crosslinking agent with the polyorganosiloxane containing aliphatic carbon-carbon multiple bonds and trifluoropropyl groups is achieved by incorporating trifluoropropyl groups into the SiH crosslinking agent. Moreover, it was surprisingly discovered that these SiH crosslinking agents containing trifluoropropyl groups must not contain H—SiRR′—O units, since otherwise the processing time or the pot life is not sufficient.

### DETAILED DESCRIPTION OF THE PREFERRED EMBODIMENT(S)

The invention therefore relates to curable silicone materials containing
(A) 100 parts by weight of at least one polyorganosiloxane having a viscosity of 500 to 2,000,000 mPa·s, which has at least two radicals having aliphatic carbon-carbon multiple bonds and at least 5 mol % of 3,3,3-trifluoropropylsiloxy units or at least 5 mol % of bis(3,3,3-trifluoropropyl)siloxy units, or mixtures thereof
(B) 0.1 to 50 parts by weight of one or more organosilicon compounds which contain at least two, preferably at least three, silicon-bonded hydrogen atoms per molecule, have at least 2.5 mol % of 3,3,3-trifluoropropylsiloxy units or at least 2.5 mol % of bis(3,3,3-trifluoropropyl)siloxy units (or both), and contain no H—SiRR′—O units, and additionally the ratio of hydrogen atoms of the crosslinking agent (B) which are bonded to silicon to the carbon-carbon multiple bond of the polyorganosiloxane (A) is at least 1.1:1,
(C) 1 to 90 parts by weight of reinforcing filler having a specific surface area of at least 50 m²/g and
(D) a hydrosilylation catalyst.

The composition of the polylorganosiloxane (A) containing carbon-carbon multiple bonds preferably corresponds to the average general formula (1)
R¹ₓR²_{y}SiO_{(4-x-y)/2} (1)
in which
R¹, independently of one another, denote monovalent, optionally halogen- or cyano-substituted C₁-C₁₀-hydrocarbon radicals which are optionally bonded to silicon via an organic divalent group and which contain aliphatic carbon-carbon multiple bonds,
R², independently of one another, denote monovalent optionally halogen- or cyano-substituted C₁-C₁₀-hydrocarbon radicals which are bonded via SiC bonds and are free of aliphatic carbon-carbon multiple bonds, with the proviso that at least 5 mol % of 3,3,3-trifluoropropylsiloxy units, at least 5 mol % of bis(3,3,3-trifluoropropyl)siloxy units or at least 5 mol % of both these unites are contained in the polyorganosiloxane (A)
x denotes such a non-negative number, with the proviso that at least two radicals R¹ are present in each molecule, and
y denotes a non-negative number, with the proviso that on average, the sum (x+y) is in the range from 1.8 to 2.5.

The alkenyl groups R¹ are accessible to an addition reaction with an SiH-functional crosslinking agent. Usually, alkenyl groups having 2 to 6 carbon atoms, such as vinyl, allyl, methallyl, 1-propenyl, 5-hexenyl, ethynyl, butadienyl, hexadienyl, cyclopentenyl, cyclopentadienyl, cyclohexenyl, preferably vinyl and allyl, are used.

Organic divalent groups via which the alkenyl groups R¹ can be bonded to silicon of the polymer chain consist, for example, of oxyalkylene units, such as those of the average general formula (2)
—(O)ₘ[(CH₂)ₙO]ₒ— (2),
in which
m denotes the value 0 or 1, in particular 0,
n denotes values from 1 to 4, in particular 1 or 2, and
o denotes values from 1 to 20, in particular from 1 to 5.

The preferred radicals R¹ may be bonded in any position of the polymer chain, in particular to the terminal silicon atoms.

Examples of unsubstituted radicals R² are alkyl radicals such as the methyl, ethyl, n-propyl, isopropyl, n-butyl, isobutyl, tert-butyl, n-pentyl, isopentyl, neopentyl and tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical; cycloalkyl radicals such as cyclopentyl, cyclohexyl, 4-ethylcyclohexyl and cycloheptyl radicals, norbornyl radicals and methylcyclohexyl radicals; aryl radicals such as the phenyl, biphenylyl and naphthyl radical; alkaryl radicals, such as o-, m- and p-tolyl radicals and ethylphenyl radicals; aralkyl radicals, such as the benzyl radical and the α- and the β-phenylethyl radicals.

Examples of substituted hydrocarbon radicals as radicals R² are halogenated hydrocarbons such as the chloromethyl, 3-chloropropyl, 3-bromopropyl, 3,3,3-trifluoropropyl and 5,5,5,4,4,3,3-heptafluoropentyl radicals and the chlorophenyl, dichlorophenyl and trifluorotolyl radical. R² preferably has 1 to 6 carbon atoms. The methyl, 3,3,3-trifluoropropyl and phenyl radicals are particularly preferred.

The polyorganosiloxanes (A) preferably have a viscosity of 2000 to 1,000,000, more preferably 5000 to 500,000, mPa·s (25° C.). Polyorganosiloxanes (A) having at least 8 mol % of 3,3,3-trifluoropropylsiloxy or bis(3,3,3-trifluoropropyl)siloxy units are furthermore preferred, and polyorganosiloxanes (A) having at least 10 mol % of 3,3,3-trifluoropropylsiloxy or bis(3,3,3-trifluoropropyl)siloxy units are particularly preferred.

Constituent (A) may also be a mixture of different polyorganosiloxanes which contain alkenyl groups and differ, for example, in the alkenyl group content, in the type of alkenyl group, or structurally. The structure of the polyorganosiloxanes (A) containing alkenyl groups may be linear, cyclic or branched. The content of tri- and/or tetrafunctional units leading to branched polyorganosiloxanes is typically very low, preferably not more than 20 mol %, in particular not more than 0.1 mol %.

The use of polydimethylsiloxanes which contain vinyl groups and the molecules of which correspond to the average general formula (3)
(ViMe₂SiO_{1/2})₂(ViMeSiO_{2/2})_{q}(Me₂SiO_{2/2})_{q}(MeTPFSiO_{2/2})ᵣ (3)
in which Vi denotes the vinyl group, Me denotes the methyl group and TPF denotes the 3,3,3-trifluoropropyl group and p, q, and r denote non-negative integers, with the proviso that p≧0, r≧2, preferably r≧3, 50<(p+q+r)<3000, preferably 150<(p+q+r)<1000, 0<(p+1)/(p+q+r)<0.2 and r/(p+q+r)≧0.05, is particularly preferred.

SiH crosslinking agent (B), which comprises an organosilicon compound containing at least two, preferably at least three, SiH functions per molecule, preferably has a composition of the average general formula (4)
HₐR³_{b}SiO_{(4-a-b)/2} (4),
in which
R³,independently of one another, denotes monovalent, optionally halogen- or cyano-substituted C₁-C₁₀-hydrocarbon radicals which are bonded via SiC bonds and are free of aliphatic carbon-carbon multiple bonds, with the proviso that at least 2.5 mol % of 3,3,3-trifluoropropylsiloxy units, at least 2.5 mol % of bis(3,3,3-trifluoropropyl)siloxy units, or at least 2.5 mol % of both these groups and no terminal radicals HR³₂SiO_{1/2} are contained, and
a and b are non-negative integers,
with the proviso that 0.5<(a+b)<3.0, 0<a<2, and that at least two silicon-bonded hydrogen atoms per molecule are present, wherein R³ is other than a silicon-bonded hydrogen atom.

Examples of unsubstituted radicals R³ are alkyl radicals such as the methyl, ethyl, n-propyl, isopropyl, n-butyl, isobutyl, tert-butyl, n-pentyl, isopentyl, neopentyl and tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical; cycloalkyl radicals such as cyclopentyl, cyclohexyl, 4-ethylcyclohexyl and cycloheptyl radicals, norbornyl radicals and methylcyclohexyl radicals; aryl radicals such as the phenyl, biphenylyl and naphthyl radical; alkaryl radicals such as o-, m- and p-tolyl radicals and ethylphenyl radicals; aralkyl radicals such as the benzyl radical and the α- and the β-phenylethyl radical.

Examples of substituted hydrocarbons as radicals R³ are halogenated hydrocarbons such as the chloromethyl, 3-chloropropyl, 3-bromopropyl, 3,3,3-trifluoropropyl and 5,5,5,4,4,3,3-heptafluoropentyl radicals and the chlorophenyl, dichlorophenyl and trifluorotolyl radical. R³ preferably has 1 to 6 carbon atoms. Methyl, 3,3,3-trifluoropropyl and phenyl radicals are particularly preferred.

The SiH crosslinking agents (B) are free of terminal H—SiRR′—O_{1/2} units (M^{H} units; in which R and R′, independently of one another, may assume the same meaning as R³).

The use of an organosilicon compound containing three or more SiH bonds per molecule is preferred.

The hydrogen content of the organosilicon compound (B), which relates exclusively to the hydrogen atoms bonded directly to silicon atoms, is preferably in the range from 0.002 to 1.7% by weight of hydrogen, more preferably from 0.1 to 1.7% by weight of hydrogen.

The organosilicon compound (B) preferably contains at least three and not more than 600 silicon atoms per molecule. The use of an organosilicon compound which contains 4 to 200 silicon atoms per molecule is preferred. The structure of the organosilicon compound (B) may be linear, branched, cyclic or network-like.

Particularly preferred organosilicon compounds (B) are linear polyorganosiloxanes of the average general formula (5)
(R⁴₃SiO_{1/2})_{d}(HR⁴SiO_{2/2})ₑ(R⁴₂SiO_{2/2})_{f} (5)
in which
R⁴ has the meanings of R³ and
d, e, and f denote non-negative integers,
with the proviso that the equations d=2, e>2, 5<(e+f)<200 and 0.1<e/(e+f)<1 are satisfied.

The SiH-functional crosslinking agent (B) is preferably contained in the crosslinkable silicone material in an amount such that the molar ratio of the SiH groups to carbon-carbon multiple bonds is at least 1.1:1, preferably 1.1 to 5:1, particular preferably 1.1 to 3:1.

The reinforcing filler (C) preferably comprises precipitated or pyrogenic silicas, and also carbon black. Precipitated and pyrogenic silicas and mixtures thereof are preferred. Pyrogenic silica surface-treated with silylating agents is particularly preferred. The hydrophobization of the silica can be effected either before the incorporation into the polyorganosiloxane or in the presence of a polyorganosiloxane by the in situ process. Both processes can be carried out both by batch process and continuously. Silylating agents which may be used are all water repellents known to the person skilled in the art. These are preferably silazanes, in particular hexamethyldisilazane and/or 1,3-divinyl-1,1,3,3-tetramethyldisilazane, 1,3-bis(3,3,3-trifluoropropyl)tetramethyldisilazane, and/or polysilazanes, it also being possible to add water. In addition, other silylating agents such as SiOH- and/or SiCl- and/or alkoxy-functional silanes or siloxanes may also be used as water repellents. Cyclic, linear or branched nonfunctional organosiloxanes, for example, octamethylcyclotetrasiloxane or polydimethylsiloxane, may also be used, in each case by themselves or in addition to silazanes, as silylating agents. In order to accelerate the hydrophobization, the addition of catalytically active additives such as hydroxides is also possible. The hydrophobization can be effected in one step with the use of one or more water repellents, but also with the use of one or more water repellents in a plurality of steps.

Precipitated or pyrogenic silicas are preferred. A particularly preferred silica is one having a BET specific surface area of 80-400 m²/g, more preferably 100-400 m²/g.

Any catalysts which catalyze the hydrosilylation reactions which take place during the crosslinking of addition-crosslinking silicone materials can be used as a hydrosilylation catalyst (D). In particular, metals and compounds thereof, such as platinum, rhodium, palladium, ruthenium and iridium, preferably platinum, can be used as hydrosilylation catalysts. Platinum and platinum compounds are preferably used. Those platinum compounds which are soluble in polyorganosiloxanes are particularly preferred. Soluble platinum compounds which may be used are, for example, platinum-olefin complexes of the formulae (PtCl₂ olefin)₂ and H(PtCl₃ olefin), alkenes having 2 to 8 carbon atoms, such as ethylene, propylene and isomers of butene and of octene, or cycloalkenes having 5 to 7 carbon atoms, such as cyclopentene, cyclohexene and cycloheptene, preferably being used. Further soluble platinum catalysts are the platinum-cyclopropane complex of the formula (PtCl₂C₃H₆)₂, the reaction products of hexachloroplatinic acid with alcohols, ethers and aldehydes or mixtures thereof or the reaction product of hexachloroplatinic acid with methylvinylcyclotetrasiloxane in the presence of sodium bicarbonate in ethanolic solution. Complexes of platinum with vinylsiloxanes, such as sym-divinyltetramethyldisiloxane, are particularly preferred. Also suitable are the platinum compounds described in EP 1 077 226 A1 and EP 0 994 159 A1, the disclosure of which in this context is hereby incorporated by reference.

The hydrosilylation catalyst can be used in any desired form, for example also in the form of microcapsules containing hydrosilylation catalyst, or in the form of polyorganosiloxane particles, as described in EP 1 006 147 A1, the disclosure of which is also incorporated herein by reference.

The content of hydrosilylation catalysts is chosen so that the addition-crosslinkable silicone material has a metal content of 0.1 to 200 ppm, preferably of 0.5 to 40 ppm, expressed as platinum metal.

The silicone materials can alternatively contain, as a further constituent (E), optional additives in a proportion of up to 70% by weight, preferably 0.0001 to 40% by weight. These additives may be, for example, resin-like polyorganosiloxanes which differ from the polyorganosiloxanes (A), dispersants, solvents, adhesion promoters, pigments, dyes, plasticizers, organic polymers, heat stabilizers, etc. Furthermore, thixotropic constituents, such as highly disperse silica or other commercial thixotropic additives, may be contained as a constituent.

Additives which serve for establishing targeted processing times, initiation temperatures and crosslinking rates of the crosslinking materials in a specific manner may also be employed. These inhibitors and stabilizers are very well known in the area of crosslinking materials.

In addition, it is also possible to add additives such as the sulphur compounds described in EP 0 834 534 A1, the disclosure of which is herein incorporated by reference. Such additives improve compression set. In addition, hollow bodies or expandable hollow bodies may also be added. In addition, blowing agents may also be added for producing foams.

The present invention furthermore relates to a process for the preparation of curable silicone materials, a process for the preparation of crosslinked silicone elastomers from the curable silicone materials, and the silicone elastomers thus obtainable.

The preparation or compounding of the silicone materials is effected by mixing polyorganosiloxane (A) and filler (C). The crosslinking after addition of crosslinking agent (B) and hydrosilylation catalyst (D) is preferably effected by heating, preferably at 30 to 250° C., preferably at at least 50° C., in particular at at least 100° C., and most preferably at from 150-200° C.

The materials according to the invention are suitable for the preparation of addition-crosslinking RTV and LSR materials, one component preferably containing the hydrosilylation catalyst (D) in addition to (A) and (C) and the second component preferably containing the SiH crosslinking agent (B) in addition to (A) and (C).

The present invention furthermore relates to the use of the curable silicone materials for the production of shaped articles from the crosslinked silicone elastomers. For this purpose, the shaped articles are preferably produced by means of injection moulding from the LSR materials of the invention. For example, it is thus possible to obtain, from such curable silicone materials, seals which are distinguished in particular by their high fuel resistance and oil resistance.

The following examples describe the way in which the present invention can be performed in principle, but without restricting it to the contents disclosed therein.

### EXAMPLES

### Comparative Example C1

160 g of a vinyldimethylsilyloxy-terminated poly(3,3,3-trifluoropropylmethyl-co-dimethyl)siloxane containing 38 mol % of trifluoropropylsiloxy units and having a viscosity of 12,000 mPa·s (25° C.) and a vinyl content of 0.053 mmol/g were initially introduced into a kneader and mixed with 27 g of hexamethyldisilazane and 9.3 g of water, then with 100 g of pyrogenic silica having a BET surface area of 300 m²/g, heated to 100° C. and kneaded for 1 hour. Thereafter, the volatile constituents were removed in vacuo at 150° C. over the course of 2 hours and dilution was then effected with 145 g of vinyldimethylsilyloxy-terminated poly(3,3,3-trifluoropropylmethyl-co-dimethyl)siloxane containing 38 mol % of trifluoropropylsiloxy units having a viscosity of 12,000 mPa·s (25° C.).

2.1 g of an SiH-containing resin, consisting of dimethylhydrogensiloxy units and SiO₂ units (M^{H}:Q=1:0.7), having a viscosity of 51 mPa·s at 25° C. and an SiH content of 0.86%, were added to 100 g of the material prepared above.

### Comparative Example 2

Somewhat different from Comparative Example C1, 3.0 g of a linear dimethylhydrogensiloxy-terminated copolymer, consisting of dimethylsilyloxy units, methylhydrogensiloxy units and 15 mol % of trifluoropropylsiloxy units, having a viscosity of 180 mPa·s at 25° C. and an SiH content of 0.60%, were added instead of the SiH-containing resin crosslinking agent.

### Example 3

In contrast to Comparative Example C1, 3.0 g of a linear trimethylsiloxy-terminated copolymer, consisting of dimethylsiloxy units, methylhydrogensiloxy units and 15 mol % of trifluoropropylsiloxy units, having a viscosity of 170 mPa·s at 25° C. and an SiH content of 0.59%, were added instead of the SiH-containing resin crosslinking agent.

### Comparative Example C4

Somewhat different from Comparative Example C1, 3.0 g of a linear trimethylsiloxy-terminated copolymer, consisting of dimethylsiloxy units and methylhydrogensiloxy units, having a viscosity of 100 mPa·s at 25° C. and an SiH content of 0.59%, were added instead of the SiH-containing resin crosslinking agent.

Table 1 shows the effect of the SiH crosslinking agent used on the storage stability of the uncrosslinked silicone material at room temperature (25° C.). In Table 1, M^{H} denotes an HR₂SiO_{1/2} group, Q denotes an SiO_{4/2} group, D denotes an R₂SiO_{2/2} group, D^{H} denotes an HRSiO_{2/2} group, D^{TFP} denotes an R(TPF)SiO_{2/2} group, in which TPF represents the 3,3,3-trifluoropropyl radical, M denotes an R₃SiO_{2/2} group and x, y and z denote non-negative integers.

TABLE 1

| | | | Viscosity |
|---|---|---|---|
| | Structure of SiH | Initial viscosity | after 4 weeks |
| Example | crosslinking agent | [Pa · s] | at 25° C. [Pa · s] |
| C1 | M^{H}ₓQ_{y} | 690 | 890 |
| C2 | M^{H}DₓD^{H}_{yD}^{TFP}_{z}M^{H} | 730 | 820 |
| 3 | MDₓD^{H}_{y}D^{TFP}_{z}M | 710 | 720 |
| C4 | MDₓD^{H}_{z}M | 740 | 760 |

From Table 1, it is evident that the use of an SiH crosslinking agent which contains no MH unit results in a considerable improvement in the storage stability.

### Comparative Example C5

160 g of a vinyldimethylsiloxy-terminated poly(3,3,3-trifluoropropylmethyl-co-dimethyl)siloxane containing 38 mol % of trifluoropropylsiloxy units and having a viscosity of 12,000 mPa·s (25° C.) and a vinyl content of 0.053 mmol/g were initially introduced into a kneader and mixed with 27 g of hexamethyldisilazane and 9.3 g of water, then mixed with 100 g of pyrogenic silica having a BET surface area of 300 m²/g, heated to 100° C. and kneaded for 1 hour. Thereafter, volatile constituents were removed in vacuo at 150° C. in the course of 2 hours and the dilution was then effected with 150 g of vinyldimethylsiloxy-terminated poly(3,3,3-trifluoropropylmethyl-co-dimethyl)siloxane containing 38 mol % of trifluoropropylsiloxy units having a viscosity of 12,000 mPa·s (25° C.).

0.16 g of a solution which has a Pt content of 1% by weight and contains a platinum-sym-divinyltetramethyldisiloxane complex was added to 100 g of the material prepared above.

By mixing 100 g of this platinum-containing material with 100 g of the crosslinking agent-containing material prepared in Comparative Example C1 and adding 0.14 g of ethynylcyclohexanol, an addition-crosslinking material was obtained.

### Comparative Example C6

Similarly to Comparative Example C5, 100 g of the crosslinking agent-containing material prepared in Comparative Example C2 were mixed with 100 g of the platinum-containing material prepared in Comparative Example C5, and 0.14 g of ethynylcyclohexanol was added.

### Example 7

In contrast to Comparative Example C5, 100 g of the crosslinking agent-containing material prepared in Example 3 were mixed with 100 g of the platinum-containing material prepared in Comparative Example C5, and 0.14 g of ethynylcyclohexanol was added.

### Comparative Example C8

As in Comparative Example C5, 100 g of the crosslinking agent-containing material prepared in Comparative Example C4 were mixed with 100 g of the platinum-containing material prepared in Comparative Example C5, and 0.14 g of ethynylcyclohexanol was added.

Table 2 shows the effect of the SiH crosslinking agent used on the pot life of the silicone material at room temperature (25° C.). In Table 2, M^{H}, Q, D, D^{H}, D^{TFP}, M, x, y and z have the same meaning as in Table 1.

TABLE 2

| | Structure of SiH | Pot life of the addition-crosslinking |
|---|---|---|
| Example | crosslinking agent | materials at room temperature [days] |
| C5 | M^{H}ₓQ_{y} | <1 |
| C6 | M^{H}DₓD^{H}_{yD}^{TFP}_{z}M^{H} | 5 |
| 7 | MDₓD^{H}_{y}D^{TFP}_{z}M | >7 |
| C8 | MDₓD^{H}_{y}M | >7 |

From Table 2, it is evident that the use of an SiH crosslinking agent which contains no M^{H} units results in a substantially longer pot life.

### Comparative Example C9

The addition-crosslinking material which was prepared in Comparative Example C5 and contains both SiH crosslinking agent and platinum catalyst was crosslinked in a hydraulic press at a temperature of 165° C. in the course of 2 minutes to give a silicone elastomer film.

### Comparative Example C10

The addition-crosslinking material which was prepared in Comparative Example C6 and contains both SiH crosslinking agent and platinum catalyst was crosslinked in a hydraulic press at a temperature of 165° C. in the course of 2 minutes to give a silicone elastomer film.

### Example 11

The addition-crosslinking material which was prepared in Example 7 and contains both SiH crosslinking agent and platinum catalyst was crosslinked in a hydraulic press at a temperature of 165° C. in the course of 2 minutes to give a silicone elastomer film.

### Comparative Example C12

The addition-crosslinking material which was prepared in Comparative Example C8 and contains both SiH crosslinking agent and platinum catalyst was crosslinked in a hydraulic press at a temperature of 165° C. in the course of 2 minutes to give a silicone elastomer film.

Table 3 shows the effect of the SiH crosslinking agent used on the mechanical properties of the crosslinked silicone elastomer. In Table 3, M^{H}, Q, D, D^{H}, D^{TFP}, M, x, y and z have the same meaning as in Table 1.

TABLE 3

| | Structure of SiH | | Tensile | |
|---|---|---|---|---|
| | crosslinking | Hardness | Strength | Elongation |
| Example | agent | [Shore A] | [N/mm²] | at break [%] |
| C9 | M^{H}ₓQ_{y} | 35 | 5.8 | 390 |
| C10 | M^{H}DₓD^{H}_{yD}^{TFP}_{z}M^{H} | 42 | 6.9 | 450 |
| 11 | MDₓD^{H}_{y}D^{TFP}_{z}M | 44 | 7.1 | 460 |
| C12 | MDₓD^{H}_{z}M | 36 | 2.1 | 180 |

From Table 3, it is evident that the use of an SiH crosslinking agent which contains trifluoropropyl groups and no MH units permits complete crosslinking of the silicone elastomer, so that very good mechanical properties are obtained.

### Comparative Example 13

In contrast to Example 3, only 1.04 g of SiH crosslinking agent were added to the silicone material described in Comparative Example C1 and containing 100 g of filler. 100 g of this material containing crosslinking agent were mixed with 100 g of the platinum-containing silicone material prepared in Comparative Example C5, 0.14 g of ethynylcyclohexanol was added and crosslinking was effected as described in Comparative Example C9 to give a silicone elastomer film.

Table 4 shows the effect of the SiH/vinyl ratio on the mechanical properties of the crosslinked silicone elastomer. In Table 4, D, D^{H}, D^{TFP}, M, x, y and z have the same meaning as in Table 1.

TABLE 4

| | Structure of SiH | SiH/SiVinyl ratio | Hardness |
|---|---|---|---|
| Example | crosslinking agent | [mol/mol] | [Shore A] |
| 11 | MDₓD^{H}_{y}D^{TFP}_{z}M | 2.3 | 44 |
| C13 | MDₓD^{H}_{y}D^{TFP}_{z}M | 0.8 | 15 |

From Table 4, it is evident that an excess of SiH group must be present in order to permit complete crosslinking of the silicone material.

In order to check the resistance to nonpolar media, the silicone elastomers prepared in Example 11 and Comparative Examples C9, C10 and C12 were stored in heptane and diesel fuel for 24 hours at room temperature. Cylindrical mouldings having a diameter of 10 mm and a thickness of 6 mm were used.

Table 5 shows the effect of the SiH crosslinking agent used on the resistance to media. In Table 5, M^{H}, Q, D, D^{H}, D^{TFP}, M, x, y and z have the same meaning as in Table 1.

TABLE 5

| | |
|---|---|
| | Volume swelling |
| | [%] after 24 |
| | hours at room |
| Structure of SiH | temperature in |

| Example | crosslinking agent | heptane | diesel |
|---|---|---|---|
| C9 | M^{H}ₓQ_{y} | 68 | 15.5 |
| C10 | M^{H}DₓD^{H}_{y}D^{TFP}_{z}M^{H} | 66 | 14.6 |
| 11 | MDₓD^{H}_{y}D^{TFP}_{z}M | 64 | 14.2 |
| C12 | MDₓD^{H}_{z}M | 68 | 15.8 |

From Table 5, it is evident that the use of an SiH crosslinking agent which contains trifluoropropyl groups and no M^{H} units improves the resistance to media.

### Example 14

In contrast to Example 7, 0.33 g of the organosulphur-containing filler described in DE 196 34 971 A1, Example 1, and 0.14 g of ethynylcyclohexanol are added to the material containing SiH crosslinking agent before the 100 g of material containing SiH crosslinking agent is mixed with 100 g of platinum-containing material. Crosslinking is effected under the conditions described in Example 9.

Table 6 shows the effect of the sulphur-containing filler on the compression set of the crosslinked silicone elastomer.

TABLE 6

| Example | Hardness [Shore A] | Compression set [%] |
|---|---|---|
| 11 | 44 | 55 |
| 14 | 43 | 20 |

From Table 6, it is evident that the addition of the sulphur-containing filler substantially improves the compression set.

### Example 15

In contrast to Example 14, 4% by weight of a trimethylsiloxy-terminated copolymer, consisting of dimethylsiloxy units and 80 mol % of phenylmethylsiloxy units, having a viscosity of 60 mPa·s at 25° C., are also added to the uncrosslinked silicone material prior to crosslinking. The crosslinking is effected under the conditions described in Example 9.

Table 7 shows the effect of the sulphur-containing filler on the compression set and of the phenyl-containing copolymer on the exudation behaviour.

TABLE 7

| | | Oil film present on the silicone | Compression |
|---|---|---|---|
| | Hardness | elastomer film after storage for | set |
| Example | [Shore A] | one day at room temperature | [%] |
| 11 | 42 | no | 53 |
| 15 | 41 | yes | 19 |

From Table 7, it is evident that the addition of the sulphur-containing filler substantially improves the compression set and the addition of the oil results in a self-lubricating effect.

The silicone elastomer properties were characterized according to DIN 53505 (Shore A), DIN 53504-S1 (tensile strength and elongation at break), DIN 53517 (compression set, 22 hours at 175° C.). The viscosity was determined at a shear rate of 10 s⁻¹.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A curable silicone material comprising:
(A) 100 parts by weight of at least one polyorganosiloxane having a viscosity of 500 to 2,000,000 mPa·s, which has at least two radicals having aliphatic carbon-carbon multiple bonds and at least 5 mol % of one or both of 3,3,3-trifluoropropylsiloxy units and bis(3,3,3-trifluoropropyl)siloxy units,
(B) 0.1 to 50 parts by weight of one or more organosilicon crosslinking agent(s) which contain at least two hydrogen atoms per molecule which are bonded to silicon, have at least 2.5 mol % of one or both of 3,3,3-trifluoropropylsiloxy units and bis(3,3,3-trifluoropropyl)siloxy units and contain no terminal H—SiR³₂—O_{1/2}-units, and additionally the ratio of hydrogen atoms of the crosslinking agent (B) which are bonded to silicon to the carbon-carbon multiple bond of the polyorganosiloxane (A) is at least 1.1:1,
(C) 1 to 90 parts by weight of reinforcing filler having a specific surface area of at least 50 m²/g, and
(D) a hydrosilylation catalyst, wherein R³ is other than a silicon-bonded hydrogen atom.

2. The curable silicone material of claim 1, wherein the polyorganosiloxane (A) containing carbon-carbon multiple bonds is represented by the average formula (1)
R¹ₓR²_{y}SiO_{(4-x-y)/2} (1)
in which
R¹, independently of one another, denote monovalent, optionally halogen- or cyano-substituted C₁-C₁₀-hydrocarbon radicals which are optionally bonded to silicon via an organic divalent group and contain aliphatic carbon-carbon multiple bonds,
R², independently of one another, denote monovalent, optionally halogen- or cyano-substituted C₁-C₁₀-hydrocarbon radicals which are bonded via an SiC bond and are free of aliphatic carbon-carbon multiple bonds, with the proviso that at least 5 mol % of one or both of 3,3,3-trifluoropropylsiloxy units and bis(3,3,3-trifluoropropyl)siloxy units are contained in the polyorganosiloxane (A),
x denotes a non-negative number, such that at least two radicals R¹ are present in each molecule, and
y denotes a non-negative number, with the proviso that the sum (x+y) is in the range from 1.8 to 2.5.

3. The curable silicone material of claim 1, wherein the SiH crosslinking agent (B) is an organosilicon compound of the average formula (4)
HₐR³_{b}SiO_{{4-a-b)/2} (4),
in which
R³, independently of one another, denote monovalent, optionally halogen- or cyano-substituted C₁-C₁₀-hydrocarbon radicals which are bonded via an SiC bond and are free of aliphatic carbon-carbon multiple bonds, with the proviso that at least 2.5 mol % of one or both of 3,3,3-trifluoropropylsiloxy units and bis(3,3,3-trifluoropropyl)siloxy units are present and no terminal radicals HR³₂SiO_{1/2} are present, and
a, b are non-negative integers,
with the proviso that 0.5<(a+b)<3.0, 0<a<2, and that at least two silicon-bonded hydrogen atoms per molecule are present.

4. The curable silicone material of claim 1, wherein the SiH crosslinking agent (B) is an organosilicon compound of the average formula (5)
(R⁴₃SiO_{1/2})_{d}(HR⁴SiO_{2/2})ₑ(R⁴₂SiO_{2/2})_{f} (5),
in which
R⁴ independently of one another, denote monovalent, optionally halogen- or cyano-substituted C₁-C₁₀-hydrocarbon radicals which are bonded via an SiC bond and are free of aliphatic carbon-carbon multiple bonds, with the proviso that at least 2.5 mol % of one or both of 3,3,3-trifluoropropylsiloxy units and bis(3,3,3-trifluoropropyl)siloxy units are present and no terminal radicals HR³₂SiO_{1/2} are present, and
d, e, and f denote non-negative integers,
with the proviso that the equations d=2, e>2, 5<(e+f)<200 and 0.1<e/(e+f)<1 are satisfied.

5. The curable silicone material of claim 1, wherein the SiH-functional crosslinking agent (B) is contained in the curable silicone material in an amount such that the molar ratio of SiH groups to carbon-carbon multiple bonds is 1.1:1 to 5:1.

6. The curable silicone material of claim 1, wherein the reinforcing filler (C) is selected from the group consisting of precipitated silicas, pyrogenic silicas, carbon black, and mixtures thereof.

7. The curable silicone material of claim 1, wherein at least one hydrosilylation catalyst (D) is selected from the group consisting of the metals platinum, rhodium, palladium, ruthenium and iridium and compounds thereof.

8. The curable silicone material of claim 1, wherein the curable silicone materials further comprise 0.0001 to 70% by weight of further constituents selected from the group consisting of resin-like polyorganosiloxanes which differ from the polyorganosiloxanes (A), dispersants, solvents, adhesion promoters, pigments, dyes, plasticizers, organic polymers, hollow spheres, expandable hollow spheres, heat stabilizers, highly disperse silica, and thixotropic additives.

9. A process for the preparation of a curable silicone material of claim 1, comprising mixing together constituents (A) to (D).

10. The process of claim 9, wherein one component contains the hydrosilylation catalyst (D) in addition to (A) and (C) and a second component contains the SiH crosslinking agent (B) in addition to (A) and (C).

11. An addition-crosslinking RTV or LSR material, comprising the curable silicone material of claim 1.

12. A silicone elastomer prepared by addition crosslinking of a curable silicone material of claim 1.

13. A process for the preparation of a silicone elastomer of claim 12, comprising compounding a component containing at least one polyorganosiloxane (A) and at least one filler (C) with a further component containing at least one crosslinking agent (B) and the hydrosilylation catalyst (D), and crosslinking the compounded components.

14. A process for the preparation of a silicone elastomer of claim 13, wherein crosslinking is effected by heating above room temperature.

15. An elastomeric seal comprising a silicone elastomer of claim 12.
